(19) United States
(12) Patent Application Publication
(10) Pub. No.: US 2009/0080762 A1
(43) Pub. Date: Mar. 26, 2009

(54) Appearance for inspection method

(75) Inventor: Noriko Kobayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/232,487

(22) Filed: Sep. 18, 2008

(30) Foreign Application Priority Data
Sep. 21, 2007 (JP) 244705/2007

(51) Int. Cl. G06K 9/00

(52) U.S. Cl. 382/145

(57) ABSTRACT

To be provided is an appearance inspection method of acquiring an accurate data regarding a chipping of a semiconductor chip generated by a dicing step. It includes: acquiring the image data of the semiconductor chip; binary-processing the image data; recognizing a chipping end 23 provided in the semiconductor chip from the binary-processed image data; setting a reference line 17 in an element formation region side of the semiconductor chip from the chipping end; and measuring a distance from the reference line 17 to the chipping end 23 are provided.

### BACKGROUND OF THE INVENTION

1. Field of the Invention

The present invention relates to an appearance inspection method of a semiconductor chip.

2. Description of the Related Art

In general, at the time of mounting a semiconductor chip, a state of a defect (hereinafter, referred to as chipping) such as a crack or a chip generated in a dicing step is inspected by an appearance inspection device, thereby to determine whether the semiconductor chip is defective or non-defective. Here, only the semiconductor chip determined as non-defective is transferred to the next mounting step.

Heretofore, the appearance inspection of the semiconductor chip after the dicing step has been performed by the following method. (Since the present technology is not involved in the invention publicly known by the application, the prior art literature information is not described). Now, a description will be made by using FIGS. 3 to 5. FIG. 3 is a schematic illustration showing a configuration of the appearance inspection device. FIG. 4 is a top plan view of a semiconductor chip 11 after a dicing step. A wafer ring 13 is a jig used in the dicing step, and holds the semiconductor chip through a dicing sheet 12.

In FIG. 3, the semiconductor chip 11 is introduced into the appearance inspection device, and by an imaging portion 14 such as a camera, an image data in the vicinity of the scribe line of the semiconductor chip 11 is acquired. Further, the image data is binary-processed by a processing portion 15, thereby, for example, a portion left without being cut 20 is recognized as white, and a dicing place including a dicing line 21 and a chipping is recognized as black. An example of the binary-processed image data is shown in FIG. 5. Here, by a recognizing portion 16 of the appearance inspection device, a virtual dicing line end 102 is set from the shape of the dicing end. The virtual dicing line end 102, for example, is set by reading the trough parts of the wavy line of the dicing end having ruggedness. Further, for example, by recognizing a sharp angle chipping 103 and measuring a length between the virtual dicing line end 102 and a chipping end 104, a chipping amount 105 is determined. The chipping end 104 indicates the top end of the chipping. For example, if the chipping amount 105 is within the predetermined margin, the semiconductor chip is determined as non-defective, and if exceeding the predetermined margin, determined as defective.

As a relative literature, Japanese Patent Laid-Open No. 1-207878 (Patent Document 1) is cited. The Patent Document 1 relates to a device for automatically inspecting a defect generated in the surface contour portion of the semiconductor, and this device is configured to include a step of determining non-defective or defective by comparing the data wholly imaging an object and the basic contour data of the object.

### SUMMARY

In the Related Art, the chipping amount 105 was measured based on the virtual dicing line end 102. However, depending on the “deflection” and the like of the blade in the dicing, as shown in FIG. 5, it is often the case that the dicing end protrudes to the outside (inner side direction of the semiconductor chip) of the original dicing line end 101 (upward). Consequently, the virtual dicing line end 102 estimated from here has often been recognized further at the outside than the original dicing line end 101. Here, the dicing line end 101 indicates an end of the dicing line 21 located at the center of the scribe line and corresponding to the blade width used for dicing.

In this case, since the chipping amount 105 is a value measured based on the virtual dicing line end 102 erroneously recognized, it results in the erroneously recognized chipping amount 105. An actual chipping amount 106 is based on the dicing line end 101, and indicates a length between the dicing line end 101 and the chipping end 104. Since the predetermined margin of the chipping amount corresponds to the actual chipping amount 106, there has been a problem that, by the erroneously recognized chipping amount 105, an accurate determination regarding the non-defective or defective semiconductor chip cannot be performed.

According to the present invention, an appearance inspection method of the semiconductor chip is provided, which comprises the steps of: acquiring the image data of a semiconductor chip; binary-processing the image data; recognizing a chipping end provided in the semiconductor chip from the binary-processed image data; setting a reference line in an element formation region side of the semiconductor chip from the chipping end; and measuring a distance from the reference line to the chipping end.

The present invention, in the method of inspecting the appearance of the semiconductor chip, measures a distance (chipping allowance amount) between the reference line provided in the semiconductor chip and the chipping end generated by dicing based on the binary-processed image data. The reference line and the chipping end provided in the semiconductor chip can be accurately recognized from the binary-processed image data. Hence, because they are not erroneously recognized, the data regarding the chipping can be accurately acquired.

Note that “the reference line” is formed inside the semiconductor chip, and may be clearly recognized appearance-wise, and for example, it may be the scribe line end or a seal-ring end formed in the outer edge of an element formation region or a characteristic pattern, and the like.

According to the present invention, since accurate data regarding the chipping in the semiconductor chip can be acquired, an accurate determination on the non-defective or defective semiconductor chip can be performed.

### BRIEF DESCRIPTION OF THE DRAWINGS

FIG. 1 shows an image data according to the embodiments of the present invention;

FIG. 2 shows an enlarged view of the image data according to the embodiments of the present invention;

FIG. 3 shows a schematic illustration of an appearance inspection device;

FIG. 4 shows a top plan view of a semiconductor chip of an inspection target; and

FIG. 5 shows the image data for describing the Background Art of the present invention.

### DETAILED DESCRIPTION OF THE PREFERRED EMBODIMENTS

### First Embodiment

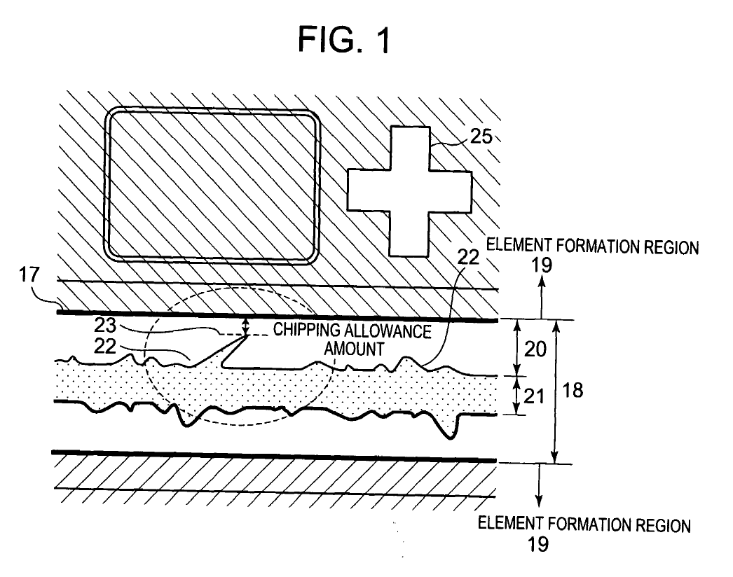

A first embodiment of the present invention will be described by using FIGS. 1 to 3.

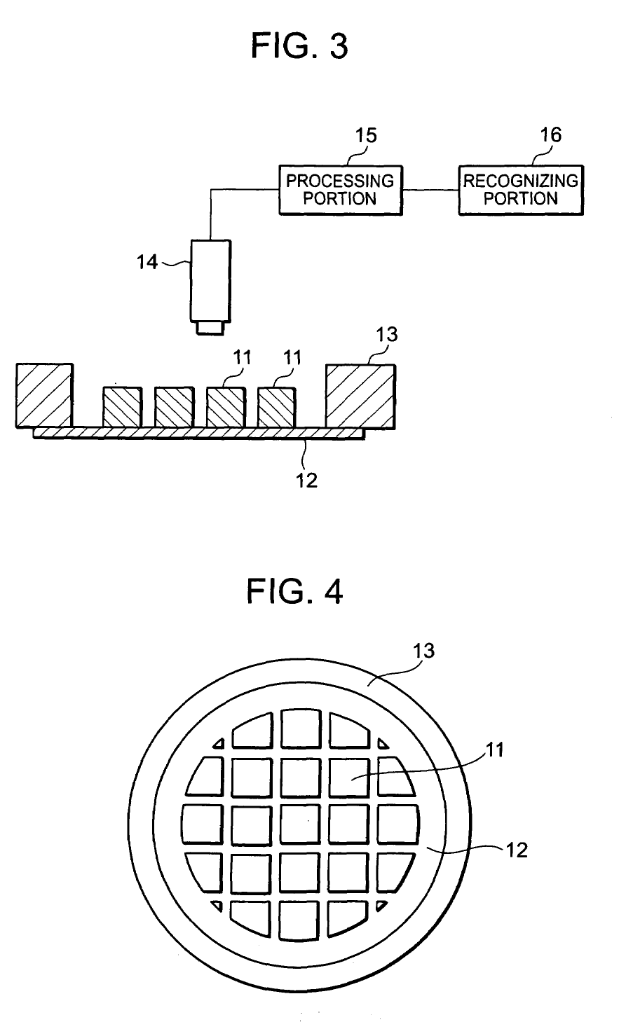

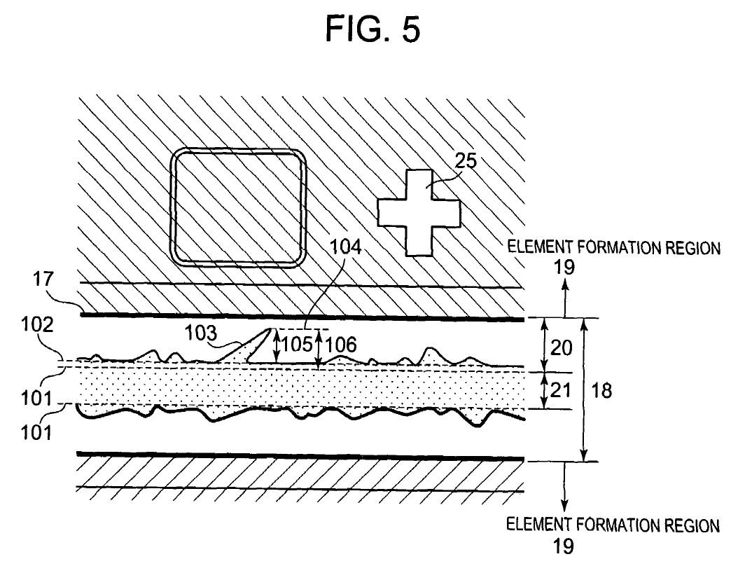

A discrete semiconductor chip 11 is introduced into an appearance inspection device in a state of being adhered to a dicing sheet 12 (FIG. 3). A wafer ring 13 is a jig used in the step of dicing the semiconductor wafer, and holds the semiconductor chip 11 through the dicing sheet 12. FIG. 4 is a top plan view showing individual semiconductor chips 11 held in the wafer ring 13.

The appearance inspection device acquires an image in the vicinity of the scribe line in the semiconductor chip 11 by an imaging portion 14. The acquisition of the image data can be smoothly performed, for example, by allowing the appearance inspection device to store an arbitrary characteristic pattern inside the semiconductor chip and disposed in the vicinity of scribe line, thereby to detect the position of the characteristic pattern.

Next, the image data is binary-processed by the processing portion 15 of the appearance inspection device. An example of the binary-processed image data is shown in FIG. 1. A scribe line region 18 and an element formation region 19 are observed. When binary-processed, a portion left without being cut 20 inside the scribe line region 18 is recognized white, whereas a dicing line 21 and a chipping 22 are recognized black. By binary-processing the image data in this manner, a scribe line end 17 and a chipping end 23 in the vicinity of the scribe line are given light and darkness, so that they can be accurately recognized. Reference numeral 25 in Figure denotes the characteristic pattern as described above.

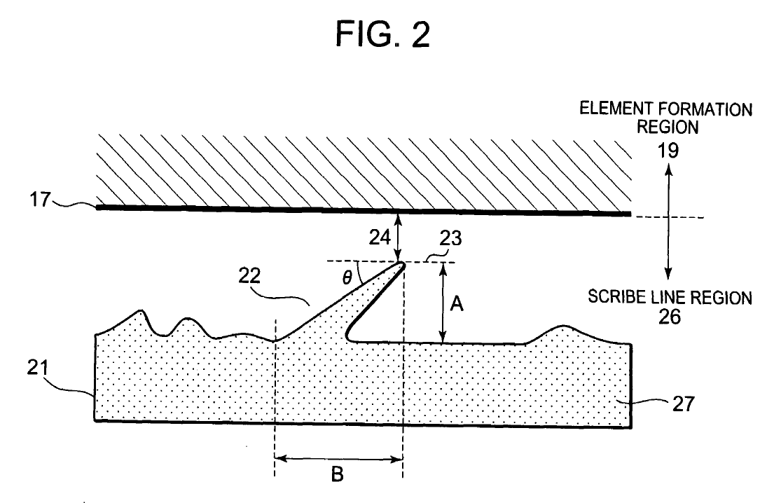

Subsequently, the reference line and the chipping end provided in the semiconductor chip are recognized. FIG. 2 is an enlarged view in the vicinity of the region surrounded by a circle in FIG. 1. In the present embodiment, the scribe line end 17 is recognized as a reference line provided in the semiconductor chip. Further, as a chipping end, the chipping end 23 nearest to the scribe line end is recognized. Note that the scribe line end 17 serving as the reference line is recognized first, and from thence, scan is made vertical to the direction of the dicing place 27, and a boundary reached first can be recognized as the chipping end 23.

Next, a distance (hereinafter, the chipping allowance amount) 24 between the scribe line end 17 and the chipping end is measured. For example, from the measured value in terms of the image data and the magnification of the image data, an accurate chipping allowance amount can be determined.

According to the present embodiment, by taking a notice of the reference line (for example, the scribe line end) and the chipping end provided in the semiconductor chip and measuring a length between thereof, an accurate data regarding the chipping can be acquired. This is because they are never erroneously recognized. Hence, this is taken as a criterion for determination of the non-defective and the defective semiconductor chip, and therefore, an accurate determination can be performed and the productivity of the semiconductor device can be improved.

Although the measurement of the chipping allowance amount has been performed for the reference line provided in the semiconductor chip and for the chipping end nearest to the reference line, it can be also performed for an arbitrary or all the chipping ends. Similarly to the present embodiment, if the measurement is confined to the reference line provided in the semiconductor chip and the chipping end made nearest to the reference line, the inspection time can be shortened to a large degree. Particularly, if the scribe line end 17 serving as the reference line is recognized first, and from thence, scan is made vertical to the direction of the dicing place 27 so as to recognize the boundary reached first as the chipping end 23, the shortening effect of the inspection time is great.

Further, in the present embodiment, though the scribe line end has been used as the reference line provided in the semiconductor chip, this is not restrictive. If clearly recognizable in terms of the appearance, it may be a seal ring end of the element formation region outer edge or a characteristic pattern end, and the like.

### Second Embodiment

This embodiment is different from the other embodiment in that a step of comparing the chipping allowance amount with the predetermined margin amount is provided.

A comparison between the chipping allowance amount determined in the first embodiment and the predetermined margin is performed. The predetermined margin indicates a value serving as a criterion for the determination of non-defective and defective semiconductor chip, and can be arbitrarily set. Further, the predetermined margin can be stored in advance in the appearance inspection device.

Furthermore, the comparing step includes a step of determining the semiconductor chip as non-defective when the chipping allowance amount is not more than the predetermined margin, and determining the semiconductor chip as defective when the chipping allowance amount exceeds the predetermined margin.

If the above described procedure is sequentially executed for all the discrete semiconductor chips, the determination result on the non-defective or defective semiconductor chip can be mapped. From this mapping data, a step of picking up the non-defective semiconductor chip only to be transferred to the next mounting step can be also included.

Further, the scribe line width is sometimes different due to the circuit design rule and the like of the semiconductor chip. When the chipping amount is conventionally taken as a criterion for the determination of the non-defective and the defective semiconductor chip, the chipping amount allowable according to the scribe line width of the semiconductor chip also varies, and on a case by case basis, the necessity of changing the predetermined margin arises. In the present embodiment, since the chipping allowance amount is used as a criterion for determination, without depending on the scribe line width, the same predetermined margin value can be used, so that the inspection efficiency can be improved.

### Third Embodiment

This embodiment is different from the other embodiments in that a step of determining an angle (hereinafter, referred to as pitching angle) between a chipping and a dicing line is provided. A description will be made by using FIG. 2.

As described in the first embodiment, a binary-processed image data as shown in FIG. 2 is acquired. For example, by taking a notice of a chipping 22, the chipping angle thereof is determined. For example, by determining a length between A and B, a chipping angle θ can be calculated.

Depending on the chipping angle θ, for example, in the subsequent handling step and the like, there are often the cases where the chipping progresses or a defect and a chip occur. Hence, in addition to a chipping allowance amount, the chipping angle θ can be also used as a criterion for determination of the non-defective and the defective semiconductor chip.

What is claimed is:

1. An appearance inspection method of a semiconductor chip, comprising:
acquiring an image data of the semiconductor chip;
binary-processing the image data;
recognizing a chipping end provided in the semiconductor chip from the binary-processed image data;
setting a reference line in an element formation region side of the semiconductor chip from the chipping end;
and
measuring a distance from the reference line to the chipping end.

2. The appearance inspection method according to claim 1, wherein recognizing the reference line and the chipping end recognizes the chipping end nearest to the reference line in the binary-processed image data.

3. The appearance inspection method according to claim 2, wherein the recognition of the chipping end nearest to the reference line includes performing a scan in a dicing line direction from the reference line and recognizing a boundary recognized first as said chipping end.

4. The appearance inspection method according to claim 1, wherein the reference line is a scribe line end.

5. The appearance inspection method according to claim 1, further comprising:
determining an angle between said chipping end and the dicing line from said binary-processed image.

6. The appearance inspection method according to claim 1, further comprising:
comparing the distance from the reference line to the chipping end with predetermined margin.

7. The appearance inspection method according to claim 5, further comprising:
comparing the angle with predetermined margin.

8. The appearance inspection method according to claim 6, wherein comparing the distance from the reference line to the chipping end with the predetermined margin includes determining the semiconductor chip as non-defective when a distance to the reference line and the chipping end is not more than the predetermined margin and determining the semiconductor chip as defective when exceeding the predetermined margin.

9. The appearance inspection method according to claim 7, wherein comparing the angle with the predetermined margin includes determining the semiconductor chip as non-defective when a distance to the angle is not more than the predetermined margin and determining the semiconductor chip as defective when exceeding the predetermined margin.

10. The appearance inspection method according to claim 1, wherein acquiring the image data acquires an image data in the vicinity of the scribe line of the semiconductor chip based on an arbitrary pattern in the vicinity of the scribe line region stored in advance.
